(19) United States
(12) Patent Application Publication
(10) Pub. No.: US 2015/0234775 A1
(43) Pub. Date: Aug. 20, 2015

(54) ENABLING FILE ORIENTED ACCESS ON STORAGE DEVICES

(71) Applicant: Western Digital Technologies, Inc., Irvine, CA (US)

(72) Inventors: Curtis E. STEVENS, Irvine, CA (US); Christopher P. KARR, Lake Forest, CA (US)

(21) Appl. No.: 14/483,497

(22) Filed: Sep. 11, 2014

Related U.S. Application Data
(60) Provisional application No. 61/940,232, filed on Feb. 14, 2014.

(51) Int. Cl. G06F 15/177

(52) U.S. Cl. CPC G06F 15/177

(57) ABSTRACT

Systems and methods are disclosed for providing access to data storage. Certain embodiments provide a data storage device comprising a network infrastructure including a network device configured to be communicatively coupled to a network controller, a file server module coupled with the network device and configured to receive file-level or object-level commands from the host system via the network device after the host system has acquired the network address assigned by the network address server module. The data storage device further includes a boot image server module enabling the host system to boot from the data storage device.

### RELATED APPLICATION

This application claims the benefit of priority under 35 U.S.C. §119(e) of U.S. Provisional Application No. 61/940,232, filed on Feb. 14, 2014, and entitled “Enabling File Oriented Access on Storage Devices,” the disclosure of which is hereby incorporated by reference in its entirety.

### BACKGROUND

1. Field

This disclosure relates to data storage systems. More particularly, the disclosure relates to systems and methods for providing object and/or file-level access to data storage.

2. Description of Related Art

Certain data storage systems are configured to communicate with host systems and provide access to data storage thereto. Data storage devices often provide block-level access to data stored thereon to host systems.

### BRIEF DESCRIPTION OF THE DRAWINGS

Various embodiments are depicted in the accompanying drawings for illustrative purposes, and should in no way be interpreted as limiting the scope of this disclosure. In addition, various features of different disclosed embodiments can be combined to form additional embodiments, which are part of this disclosure.

FIG. 1 illustrates a block diagram of a data storage system in accordance with one or more embodiments disclosed herein.

FIG. 2 illustrates a block diagram of a data storage system in accordance with one or more embodiments disclosed herein.

FIG. 3 illustrates a block diagram of a data storage system in accordance with one or more embodiments disclosed herein.

FIG. 4 illustrates a data storage device in accordance with one or more embodiments.

FIG. 5 illustrates a data storage device in accordance with one or more embodiments.

FIG. 6 illustrates a data storage device in accordance with one or more embodiments.

FIG. 7 is a flow diagram illustrating a process 700 for accessing a data storage device by a host according to one embodiment.

FIGS. 8A and 8B illustrate data storage devices in accordance with one or more embodiments.

FIG. 9 illustrates a data storage device in accordance with one or more embodiments.

FIG. 10 illustrates a data storage device in accordance with one or more embodiments.

FIG. 11 illustrates a data storage device in accordance with one or more embodiments.

FIG. 12 is a flow diagram illustrating a process for providing storage access to a host system by a data storage device according to one or more embodiments.

### DETAILED DESCRIPTION

While certain embodiments are described, these embodiments are presented by way of example only, and are not intended to limit the scope of protection. Indeed, the novel methods and systems described herein may be embodied in a variety of other forms. Furthermore, various omissions, substitutions and changes in the form of the methods and systems described herein may be made without departing from the scope of protection.

The headings provided herein are for convenience only and do not necessarily affect the scope or meaning of the claimed invention. Disclosed herein are example configurations and embodiments relating to data storage devices generally, as well as controller board layouts in data storage devices.

### Overview

In one embodiment, a network infrastructure, e.g., a local area network (LAN) infrastructure, is provided within a network-enabled data storage device. The device and infrastructure may be added to one or more points of attachment as a virtual component. Such a configuration may allow for utilization of LAN protocols and/or upper level software compatibility with busses of attachment such as Wireless, Ethernet, Universal Serial Bus (USB), PCIe, or the like. As an example, one such device may be attached to a laptop or other computing device via one or more busses. In such a configuration, the laptop or other computing device may be able to access the virtual LAN infrastructure provided by the data storage device, as well as any services provided by the LAN infrastructure, such as address server (e.g., Dynamic Host Configuration Protocol (DHCP)), boot image server, storage server, and/or the like.

Generally, disk drives, solid state drives, hybrid drives, or similar data storage components (collectively referred to as “storage drives,” “data storage drives,” “storage devices,” or “data storage devices” below) may be attached to a system via an interface bus that is designed to transport storage commands. The commands commonly received by a storage device may contain Logical Block Addresses (LBAs) that provide placement and/or retrieval information for individual blocks of data. Blocks of data may be, for example, 512 bytes in size. In certain embodiments, the storage commands contain substantially no information regarding how the respective blocks are related to each other. That is, the storage commands do not contain object-level (e.g., “blobs”) or file-level information.

Because storage drives often provide merely block-level access, such drives are differentiated primarily based on performance metrics related to how data can be written or read across a range of LBAs. For example, speed, power consumption, vibration, security, access patterns, and the like represent performance features of interest. Such access methodology drives the storage device toward providing access profiles based on mechanical motion and mitigations for the mechanical motion such as caching. Certain embodiments disclosed herein provide for file-level and/or object-level storage access, which may allow for storage drives to assume a greater degree of control over data storage operations.

While certain embodiments are disclosed herein in the context of a particular bus, or busses, of attachment (BOA), the principles disclosed herein may be applicable to any suitable or desirable BOA. Some BOAs for data storage drives (e.g., hard disk drives (HDDs) or solid state drives (SSDs)) include Serial ATA (SATA), Serial Attached SCSI (SAS), Universal Serial Bus (USB), IEEE 1394 (FireWire), Ethernet, Wireless Local Area Network (WLAN), eMMC/UFS, Non-Volatile Memory Host Controller Interface Specification (NVMHCI), or the like. Such busses may connect to the host system via a “system bus.” Some system busses include: PCI, PCI-X, PCIe, Thunderbolt, ISA, EISA, S-100, AGP or the like.

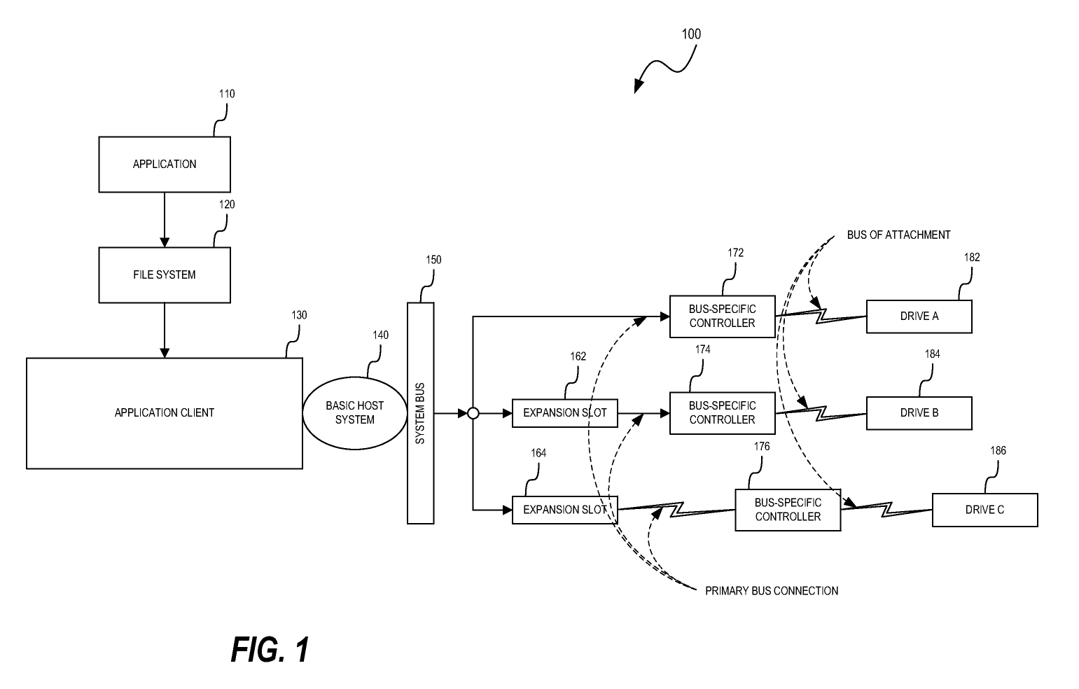

FIG. 1 illustrates a block diagram of a data storage system in accordance with one or more embodiments disclosed herein. The system 100 includes a plurality of storage drives (Drive A, Drive B, Drive C) connected to a system bus 150 over respective BOAs. Various types of BOAs may be associated with various benefits and/or disadvantages, as well as varying levels/types of system support. As example embodiments, SAS and SATA products (as well as devices using other BOA) may be configured to attach to an adapter/controller (e.g., 172, 174, 176) that allows communication with a system bus 150.

The system 100 includes a system stack including a host application 110 that may be configured to issue storage access commands. The application may interact with a host file system 120. In certain embodiments, the file system 120 and application 110 are combined in a single module. In one embodiment, an application client 130 is configured to construct storage access commands and pass such commands over the system bus to a bus-specific controller. Application clients, as described herein, may be referred to as drivers in certain contexts. The application client/driver 130 may be run by the basic host system (140), which may comprise, for example, one or more processors (e.g., CPU), system memory, built-in devices, and/or the like. In certain embodiments, communication between the BOA and the system bus 150 may be via an expansion slot (e.g., 162, 164).

The controller/adapter (e.g., 172, 174, 176) may be configured to translate storage access commands into SATA-compatible commands (or commands compatible with other busses of attachment). Some examples of application clients may include: Advanced Host Controller Interface (MCI), which may be used to connect SATA devices; Enhanced Host Controller Interface (EHCI), which may be used to connect USB devices; and SCSI Over PCIe, which may be used to connect SAS devices. Some BOAs, such as Ethernet, may not have a standard interface and may require manufacturer-sourced drivers to be operational. The various controllers of the system 100 may be integrated in the system motherboard, or may be connected through an expansion slot (e.g., 162 and 164). In certain embodiments, the expansion slot(s) are integrated on the system motherboard.

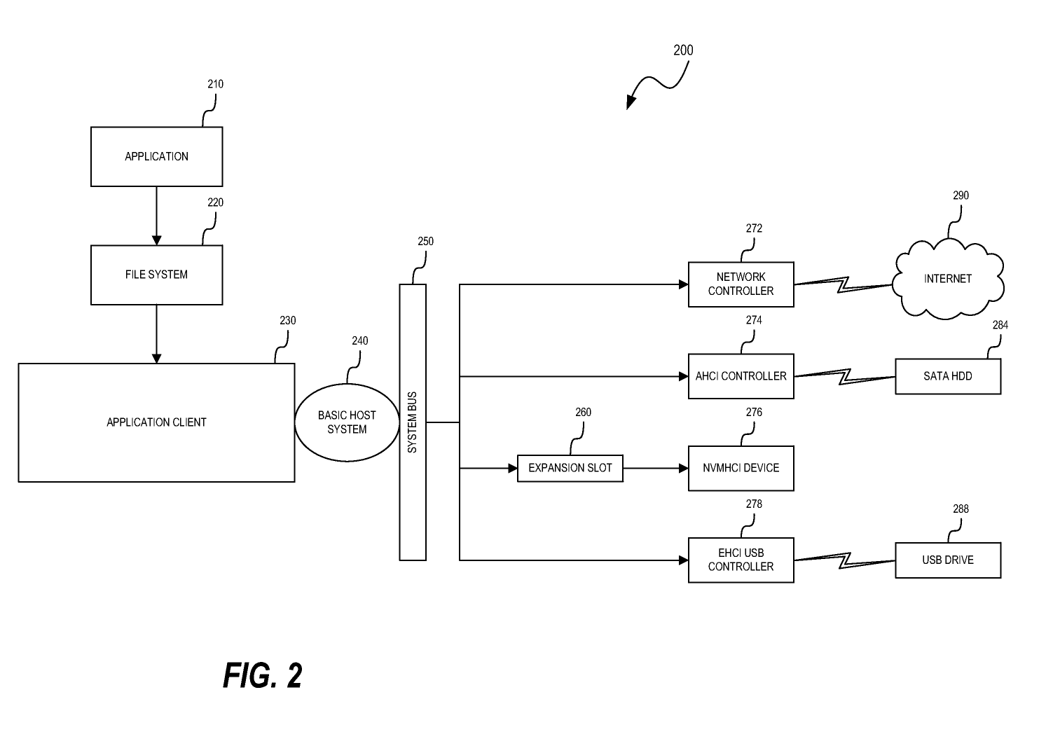

FIG. 2 illustrates a block diagram of a data storage system in accordance with one or more embodiments disclosed herein. The diagram of FIG. 2 includes specific embodiments of bus-specific controllers that may be components in a data storage system. For example, the system 200 may include a network controller 272, such as a network interface card (e.g., Ethernet, WiFi). The network controller 272 may be integrated on the system mother board, or may be attachable through an expansion slot. Furthermore, the network controller 272 may comprise a discrete chip, or may comprise a cable that is plugged into a chip. In certain embodiments, the network controller 272 is configured to connect to the Internet 290. For example, the system 200 may be configured to provide host access to a cloud-based storage server using the network controller.

In certain embodiments, the system 200 includes an on-board MCI controller 274, which may allow for attachment of a SATA hard disk drive 284 or similar SATA based storage device. The system may further include an EHCI USB controller 278, or other type of USB controller, such as an Extensible Host Controller Interface (XHCI) USB controller.

The system 200 may further include one or more NVMHCI devices 276, such as a solid-state drive (SSD) (e.g., NAND flash drive). Such devices may have built-in controllers, and therefore no additional controller may be required. The device 276 may be attached to the system motherboard through an expansion slot 260.

### File/Object-Level Storage Using Virtual Network Infrastructure

SAS and SATA interfaces may be incorporated in certain tablets, e-readers, laptops/desktops, home cloud, business cloud, external cloud, archive, CE/DVR, gaming, and/or other computing devices. SATA and SAS implement block-based protocols. USB and Ethernet protocols can provide both file and block-based protocols. The USB file protocols are referred to as Picture Transfer Protocol and Media Transfer Protocol (MTP). These protocols have good applicability for identifying files, but can be inefficient and may lack widespread support.

In some embodiments, a network-enabled data storage device (e.g., LAN-based device) can provide network protocols (e.g., LAN) and upper-level software compatibility over various BOAs that would not otherwise provide such compatibility. Various aspects of network devices (e.g., LAN devices) providing object/file-level access to data storage are described below with regard to certain examples and embodiments, which are intended to illustrate but not to limit the disclosure. Nothing in this disclosure is intended to imply that any particular feature or characteristic of the disclosed embodiments is essential. The scope of protection of certain inventions is defined by the claims.

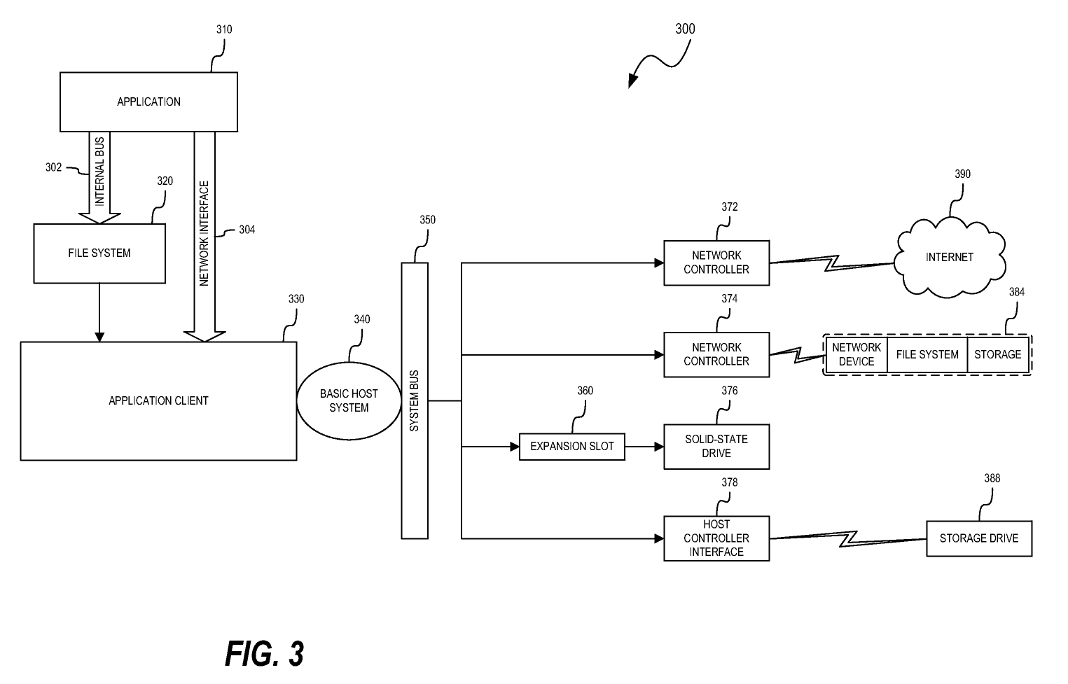

FIG. 3 illustrates a block diagram of a data storage system 300 in accordance with one or more embodiments disclosed herein. The system 300 includes a host-side system stack, wherein an application 310 may be configured to communicate with a host-side file system 320 via an internal bus 302, such as NVME or USB. In certain embodiments, one or more of the devices (376, 388) is accessed through the file system 320, which is controlled by the host-side system. Therefore, the storage devices may simply manage bits of data addressed using LBAs; data coherency is managed by the host system.

The system 300 further includes one or more devices/servers connected to the host over a network. For networked storage applications, the storage drive/server may manage the relevant file system. For example, rather than communicating with the file system 320 over the illustrated path 302, the application 310 may communicate storage access commands including file-level (or object-level) information to the storage device/server using the application client 330 over the path 304, wherein the storage device/server provides access to the stored data on a file/object basis. That is, the application 310 may issue open-file commands, as opposed to LBA-based storage access commands, wherein data organization is controlled by the drive itself.

In one embodiment of the system 300 of FIG. 3, a storage device 384 includes a network device such as a LAN interface (e.g., Ethernet) and is able to connect to a network controller 374 (e.g., LAN controller) of a host system. The host system can include additional network controllers (e.g., a network controller 372 to connect to the Internet 390) as well as other types of BOAs (e.g., EHCI USB controller) to connect to other peripheral devices such as a USB storage device. In one embodiment, the system bus 350 is a PCIe bus, which connects the various BOAs with the CPU, memory, and/or other hardware components of the host. The host can be configured to run, such as an application client 330, to control the system bus, bus specific controllers, and/or various devices.

The system of FIG. 3 illustrates one embodiment of a system that implements an alternative means by which applications address their storage. The storage device 384 (e.g., network-attached storage device (NAS)) may include a network device, file system, and storage drive (e.g., HDD) for providing file-level or object-level storage access over the network. For example, the HDD device (or other storage device, such as SSD or hybrid drives) may contain a file system that does not reside on the host. Such a configuration may effectively remove the file system management responsibility from the host. In certain embodiments, the system 300 can allow the application 310 on the host system to access data in blocks from, e.g., an NVMHCI device or a USB Drive, and files from a NAS.

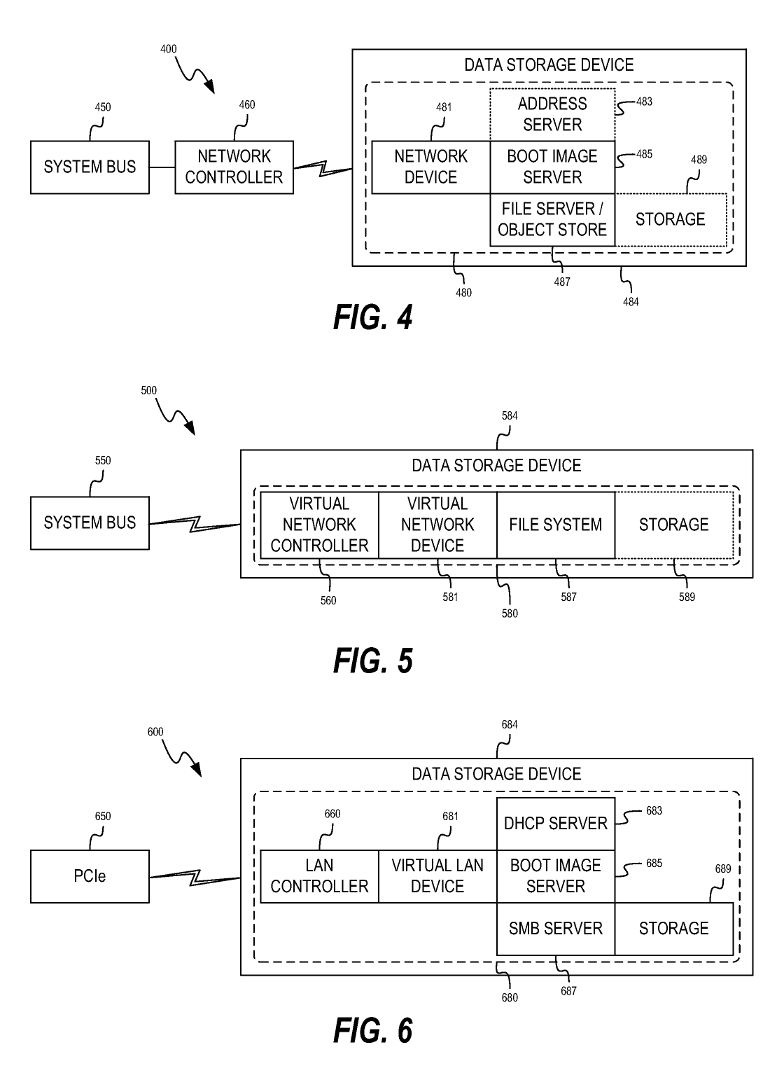

Certain embodiments disclosed herein provide a fully-populated virtual LAN structure for providing file or object-level storage to a host system. FIG. 4 is a block diagram of an embodiment of a data storage device 484 that provides such network-based access capabilities. For example, the device 484 of FIG. 4 may represent an embodiment of the storage device 384 of FIG. 3. In certain embodiments, the various illustrated components of the fully-populated network infrastructure 480 are embedded in a single device (e.g., a data storage device 484), rather than being separate components. That is, the various components of the infrastructure 480 may share a housing, processor(s), controller(s), control board(s), electrical connections/busses, and/or the like. In certain embodiments, the network infrastructure 480 may include one or more microprocessors, volatile and/or non-volatile memory capable of providing a network address server 483 (e.g., DHCP), boot image server 485 (e.g., BootP), object server and/or file server 487 (e.g., SMB2), and/or the like. In one embodiment, the network infrastructure 480 also includes a storage module 489 that includes a hard disk drive, solid state memory, and/or other non-volatile storage media.

In one embodiment, the network infrastructure 480 is setup as a virtual network infrastructure, and a host connecting to the network device 481 may be provided an IP address by the address server 483, allowing it to communicate with the network infrastructure 480. The connection between the network controller 460 and the network device 481 may be wired or wireless. In one implementation, the network infrastructure 480 acts as a private network to which only an authorized host can connect. For example, the access to one or more components of the network infrastructure 480 may be possible only via the network device 481, and may be only allowed for authenticated connections, such as limited to connection with a specific host or hosts (e.g., a host associated with the system bus 450). In certain embodiments, other devices on the same physical network as the host may not be permitted to access the private network provided by the network infrastructure 480. Such features may provide enhanced security with respect to the data stored in the storage module 489.

The network controller 460 may serve as a host-side application client. For example, the network controller 460 may comprise a host motherboard LAN controller. In LAN embodiments, the network controller may operate according to a vendor specific driver that allows the host to communicate with the LAN device. Therefore, it may be necessary for the driver to be provided to the host in the event that no standardized driver exists in the host system. Certain embodiments disclosed herein provide for the use of USB, or other standardized protocol, wherein the host operating system incorporates a generic USB network controller for communicating with the network infrastructure 480, such that the host need not acquire the appropriate driver through other means. The infrastructure 480 includes a captive file server or object store 487, depending on the type of storage access implemented.

The network infrastructure 480 may be plugged into the host system and present a virtual network interface. That is, the address server 483, boot image server 485, file server/object store 487, and/or storage module 489 may appear to the host as a network. However, the network infrastructure 480 may actually have no Internet or other network connection (hence it is acting as a virtual network infrastructure). The boot image server 485 may allow for the host to boot directly from the infrastructure 480. For example, once the host has booted, it may see the network connector 481, and determine what devices are attached thereto and/or whether such attached device(s) are bootable. The boot image server 485 may allow the host to boot therefrom. In certain embodiments, the infrastructure 480 runs an authentication protocol to ensure that the connection with the host is through the network connector 481 before providing the boot image or other services to the host. In certain embodiments, the infrastructure 480 maintains a plurality of boot images for different host devices/systems. In one embodiment, for enhanced security, the device 484 may include a controller/component/module configured to prevent access to the data storage device through connections other than through the network controller 460, thereby providing secure access to the data storage device. This enhanced security feature may be present in one or more embodiments described and shown in the following figures where a boot image server is provided.

One or more of the modules/components of the network infrastructure 480 illustrated in FIG. 4, as well as other embodiments of virtual network infrastructures disclosed herein, may comprise one or more internal state machines. Furthermore, the various network infrastructure components disclosed herein may be virtual or physical components.

As described, the system 400 provides a network device 481 (e.g., network connector) that connects to a network controller 460 (e.g., LAN controller). An Ethernet or WiFi LAN may generally provide up to a 1 Gb/s transfer rate, but may be too slow and/or costly for HDD and SSD type storage devices. In some embodiments, a transfer rate of 5-10 Gb/s or more may be desirable, and a faster bus may be used to connect the device to a system, while still being capable of using LAN protocols. One such embodiment of a LAN device (which may be referred to as SATA Express device), is illustrated in FIG. 5.

For the purpose of simplicity and avoiding repetition in the description of FIGS. 5-12 below, descriptions of certain similar and/or elements that have been previously introduced with respect to any or all of FIGS. 1-4 are omitted. In FIG. 5, the system 500 includes a network controller 560 that is a component of the network interface 580. The system 500 of FIG. 5 includes a system bus 550, such as a PCIe bus, connected to the network controller 560, which may comprise, for example, a LAN controller, wherein the network controller 560 has embedded therein a virtual network device 581, such as a virtual LAN device. Such a configuration may allow for a captive network (e.g. LAN) infrastructure 580 owned completely within a single data storage device 584 to be presented to the system bus (e.g., PCIe). The data storage device 584 may be a SATA Express device. The connection between the system bus 550 and the network controller 560 may be via a direct connection (e.g., for a board-mounted SSD), or may be via a cable or other attachment bus. As illustrated, the network infrastructure 580 may include a file system 587 and/or a storage module 589.

Although the system 500 of FIG. 5 is discussed in the context of SATA Express, it should be understood that other types of busses and/or protocols may be implemented. As referenced above, in the case where the network controller 560 is a LAN controller, the controller may require a vendor-specific driver, which may be undesirable in some conditions.

An example embodiment of the infrastructure shown in FIG. 5 is depicted in FIG. 6. FIG. 6 shows an embodiment of a data storage device 684 comprising a network infrastructure 680 that includes a LAN controller 660 with an embedded LAN attachment (virtual LAN device 681). The LAN controller 660 may be configured to provide PCIe packets over the PCIe system bus. The LAN device presents a virtual network consisting of a DHCP server, a boot image server 685 (e.g., BootP), and a storage server using the Server Message Block (SMB) protocol, or the like.

The Server Message Block (SMB) protocol has relatively widespread support. The application clients for this protocol are based on both Ethernet and wireless LAN (WLAN). Ethernet and WLAN interfaces are substantially ubiquitous and SMB is available on many of them. Furthermore, the SMB protocol can effectively be considered a universal or platform-independent file system.

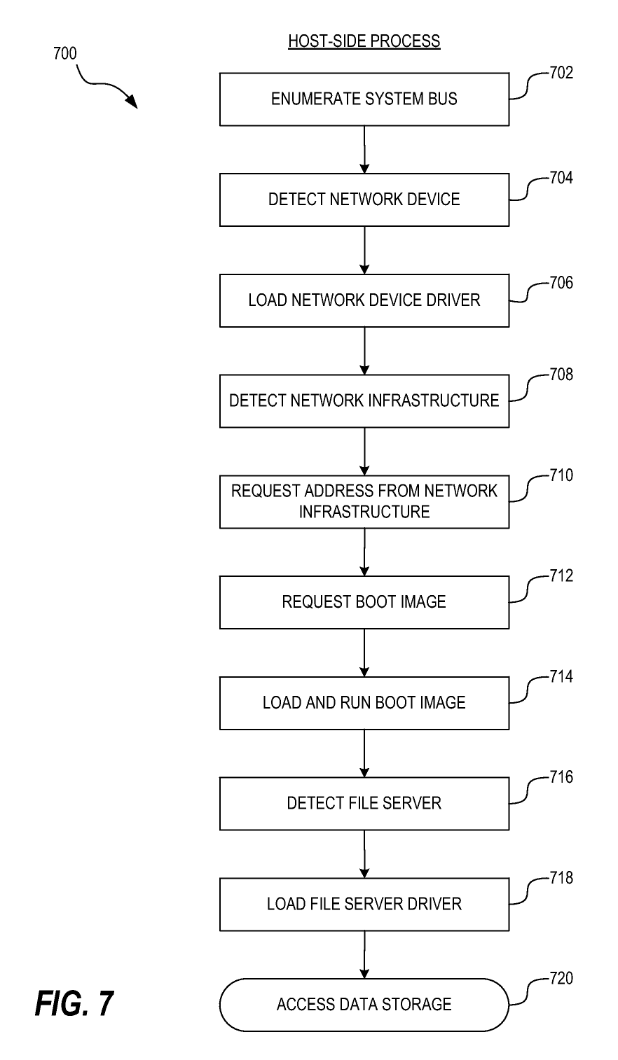

FIG. 7 is a flow diagram illustrating a process 700 for accessing a data storage device by a host according to one embodiment. For example, a host system (not shown in FIG. 6, but possibly connected via PCIe) may perform one or more of the illustrated functions upon power-up when a fully-populated network infrastructure is connected to the host. In an embodiment, the process 700 involves enumerating a system bus (block 702), such as a PCIe bus and detecting the presence of a network device (block 704), such as a LAN controller. At block 706, the host may load a driver associated with the network device (block 706), such as a LAN driver (e.g., EFI), and further detect that the network device is connected to a network infrastructure (block 708), such as a virtual LAN infrastructure. For example, the host may load a generic USB driver. A BIOS may be used in initializing the network device including the loading of appropriate driver(s).

At block 710, the process 700 involves issuing a request for an address from the network infrastructure. For example, the host may issue a request to a DHCP or other address server of the attached network infrastructure. The host may further issue a request for a boot image (e.g., BootP, Pre-Execution Environment (PXE), etc.) at block 712, wherein a boot image server of the network infrastructure provides, for example, a pointer to the boot image. At block 714, the host loads and runs the boot image.

At block 716, the operating system kernel detects a file server in the network infrastructure, such as an SMB server or the like. The operating system then loads the file server driver at block 718 (e.g., SMB client) and accesses data storage associated with the network infrastructure at block 720. Although certain embodiments are disclosed herein in the context of file servers, it should be understood that any file server disclosed herein may be an object store for serving object-based (e.g., data organized as blobs) storage requests. The process 700 may be performed at least in part by a processor of the host system. Furthermore, the process 700 may allow for booting to a Windows, Linux, or other system, wherein the host operating system may or may not comprise a file system.

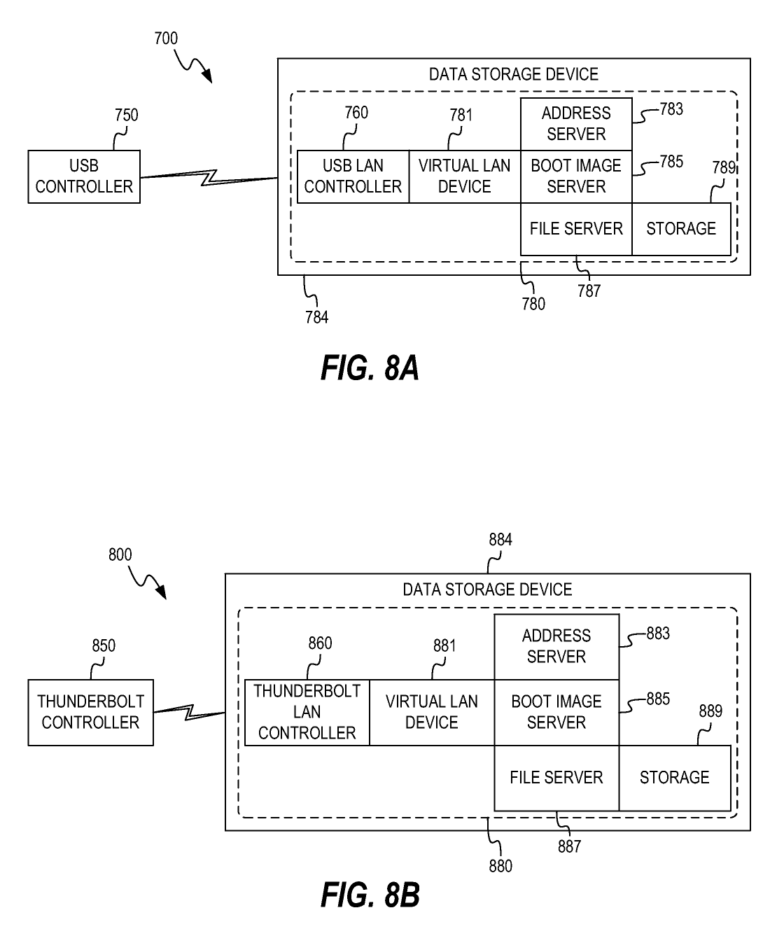

The embodiment of a network device illustrated in FIG. 6 may use standardized LAN and SMB protocols, for example. However, in the case where there is no physical Ethernet connection, the speed of the device may be limited by the speed of the PCIe connection, not the speed of Ethernet. LAN-to-PCIe connection may not have ubiquitous drivers and it may be desirable in some embodiments to utilize a more ubiquitous connection, as shown in FIGS. 8A and 8B.

FIG. 8A illustrates an embodiment of a USB-based data storage device 784 including a network infrastructure 780 (e.g., a virtual network infrastructure) that provides a ubiquitous connection to USB (e.g., USB 3.0). As shown, the system 700 includes a USB-based data storage device 784 with an embedded network infrastructure 780 such as a LAN infrastructure. Unlike the PCIe LAN controller shown in FIG. 6, the network infrastructure 780 includes a USB LAN controller 760 (coupled with a virtual LAN device 781), which may be capable of transmitting data at USB speeds of 5-10 Gb/s. This may allow the device to attach to a port (USB) that is substantially ubiquitous in modern computing devices and provide file-oriented storage using the existing infrastructure. The devices in FIGS. 8A and 8B may be configured to be attached to almost any modern host computing platform and provide full read/write file access without needing to change the underlying file system or install non-native file system drivers on the host. Therefore, the network infrastructure 780 may represent a substantially ubiquitous storage device. Alternatively, or in addition to, the USB-based device 784 shown in FIG. 8A, FIG. 8B provides a Thunderbolt-based data storage device 884 that includes a Thunderbolt controller 860, which represents another type of controller that may be used in certain embodiments.

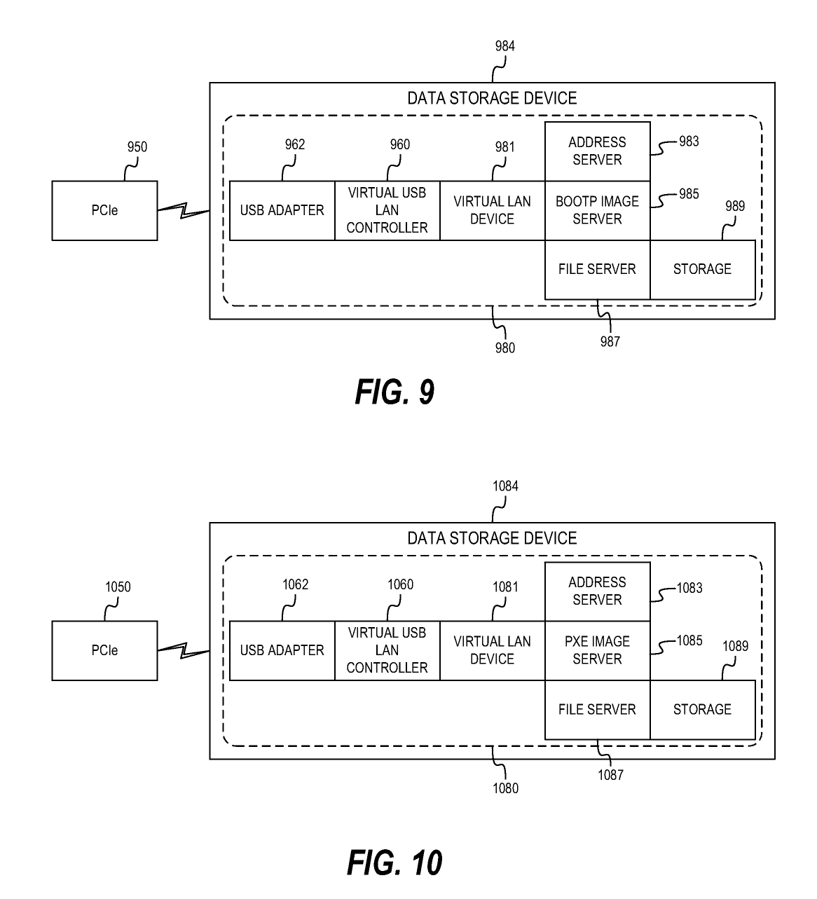

Another embodiment of a ubiquitous storage device for systems that use PCIe as the point of attachment is shown in FIG. 9. FIG. 9 illustrates an embodiment of a data storage device 984 with a network infrastructure 980 (e.g., a SATA Express device) that looks like a USB host controller to connecting host devices. The network infrastructure 980 includes a USB adapter 962, which may be, for example, an EHCI USB controller. In one embodiment, the USB host controller includes an embedded virtual USB LAN controller 960 connected to a virtual LAN device 981. Such a device may have substantially ubiquitous support for systems that support PCIe. In certain embodiments, one or more of the modules of the network infrastructure 980 (or other devices/infrastructures described herein) may be comprised of one or more internal state machines comprising transistor gates, rather than software-implemented logic. For example, one or more of the USB adapter 962, virtual USB LAN controller 960, and virtual LAN device 981 may be configured as internal state machines. The network infrastructure 980 includes a BootP image server 985, which may be used in Linux-based systems. As an alternative, FIG. 10 shows a similar attachment scheme as FIG. 9 for a data storage device 1084, wherein the boot image 1085 is configured for a Windows operating system (e.g., Pre-Execution Environment (PXE)).

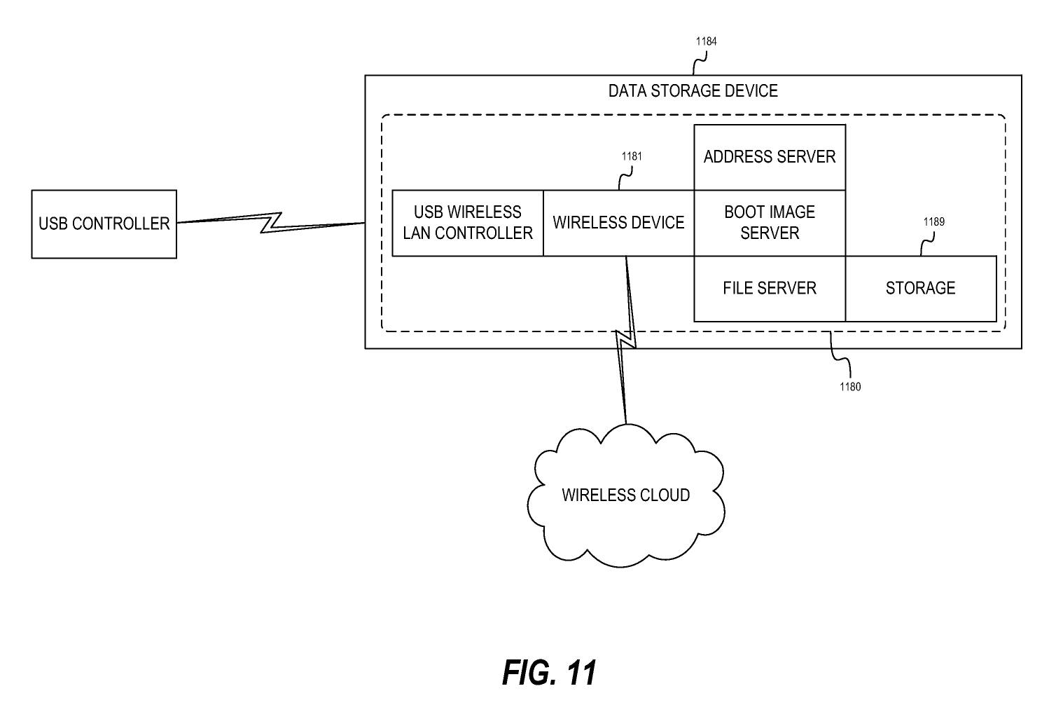

Certain embodiments disclosed herein include a Wireless LAN controller in addition to, or as an alternative to, the Ethernet controller in several of the diagrams disclosed herein. Wireless connection (e.g., WiFi) may present a relatively ubiquitous bus of attachment having greater prevalence than Ethernet. FIG. 11 illustrates an embodiment of a USB based data storage device 1184 including a network infrastructure 1180 that charges via USB and may provide its LAN infrastructure via USB. When the network infrastructure 1180 is not attached to USB, it may present a wireless connection. The connection with the wireless device 1181 (e.g., wireless transceiver) may be an authenticated connection in order to maintain adequate security with respect to the data storage 1189 and/or boot image server 1185. In certain embodiments, the configuration of FIG. 11 may allow for wireless network/Internet access over a USB connection. For example, by connecting to the data storage device 1184 over USB, a host system may achieve wireless connectivity without an independent wireless adapter. Furthermore, with the inclusion of an address server, among other components, the data storage device 1184 may provide wireless hotspot functionality in certain configurations.

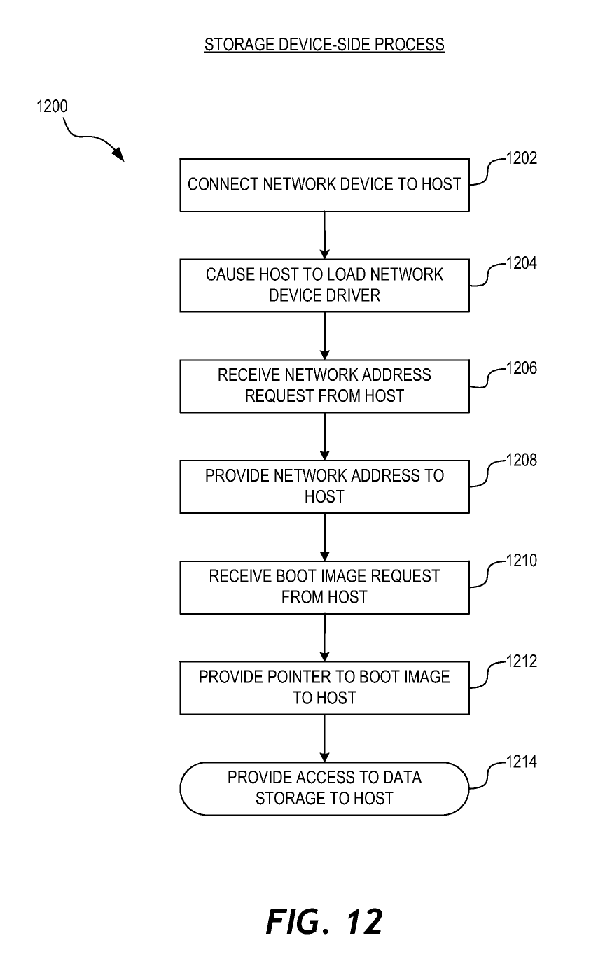

FIG. 12 is a flow diagram illustrating a process for providing storage access to a host system by a data storage device according to one or more embodiments. The process 1200 involves connecting a network device, such as a LAN device/controller, to a host system at block 1202. Such connection may be made through a physical connection port of the host system. The process 1200 further involves causing the host to load a network device driver (block 1204), which may be triggered by said attachment to the host system.

At block 1206, the storage device receives a network address request from the host and provides a network address to the host at block 1208. For example, the network address may be provided by an address server that is part of, or associated with, the data storage device. At block 1210, the storage device receives a request for a boot image from the host. The storage device further provides a pointer to the boot image to the host in response to the request received (block 1212). Once the host has booted, the process 1200 involves providing access to data storage associated with the data storage device to the host at block 1214. In certain embodiments, the process 1200 is performed at least in part by a controller of the data storage device.

The embodiments of the LAN device described above provide many possible advantages. For example, the LAN device may be implemented as storage devices that can switch from LBA-based storage to File based storage, enabling a wider range of storage technology solutions for storage device manufacturers. Hybrid storage devices, shingle magnetic recording (SMR) and other composite devices may be better able service the host in accepting and returning data.

In some embodiments, no additional host software is required for a variety of systems including Windows, Apple, Android, etc. Costs may also be reduced for host systems by offloading filesystem operations to the device.

In one embodiment, the LAN device allows a single device to present SATA, PCIe, Ethernet, Wireless LAN, and USB to connecting host systems. In an embodiment, a single LAN device may be able to connect to all the above connectors. In one embodiment, the LAN device may allow host devices to wirelessly boot from an image stored on the LAN device. The LAN device may include both a USB charging connecting and a wired attachment in the same device.

### Additional Embodiments

Those skilled in the art will appreciate that in some embodiments, other types of data storage systems can be implemented while remaining within the scope of the present disclosure. In addition, the actual steps taken in the processes discussed herein may differ from those described or shown in the figures. Depending on the embodiment, certain of the steps described above may be removed, others may be added.

Each of the processes, methods and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

While certain embodiments have been described, these embodiments have been presented by way of example only, and are not intended to limit the scope of protection. Indeed, the novel methods and systems described herein may be embodied in a variety of other forms. Furthermore, various omissions, substitutions and changes in the form of the methods and systems described herein may be made. The accompanying claims and their equivalents are intended to cover such forms or modifications as would fall within the scope and spirit of the protection. For example, the various components illustrated in the figures may be implemented as software and/or firmware on a processor, ASIC/FPGA, or dedicated hardware. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A data storage device comprising:
a network infrastructure, comprising:
a network device configured to be communicatively coupled to a network controller;
a file server module coupled with the network device, the file server module being configured to receive file-level or object-level commands from a host system via the network device ; and
a boot image server module enabling the host system to boot from the data storage device.

2. The data storage device of claim 1, wherein the network infrastructure is a local area network (LAN) infrastructure, the network device is a LAN device and the network controller is a LAN controller

3. The data storage device of claim 1, further comprising a non-volatile memory configured to interface with the file server module, thereby providing to the host system, via the network infrastructure, file-level or object-level access to data stored thereon.

4. The data storage device of claim 3, wherein the network infrastructure further comprises a network address server module coupled with the network device, the network address server module configured to issue a network address to the host system.

5. The data storage device of claim 4, wherein one or more of the network address server module, boot image server module and file server module are virtual modules.

6. The data storage device of claim 4, further comprising a boot image stored in the non-volatile memory, wherein the boot image server is configured to receive a boot image request and respond with an address associated with the boot image.

7. The data storage device of claim 4, wherein the network address server module comprises a Dynamic Host Configuration Protocol (DHCP) server.

8. The data storage device of claim 1 further comprising a controller configured to prevent access to the data storage device through connections other than through the network controller, thereby providing secure access to the data storage device.

9. The data storage device of claim 1, wherein the file server module comprises a Server Message Block (SMB) server.

10. The data storage device of claim 1, wherein the data storage device comprises the network controller.

11. The data storage device of claim 10, wherein the network controller is configured to be communicatively coupled to a system bus connector of the host system.

12. The data storage device of claim 11, wherein the network device comprises a virtual network device.

13. The data storage device of claim 11, wherein the system bus connector comprises a PCI Express (PCIe) compliant bus connector.

14. The data storage device of claim 10, wherein:
the network controller comprises a Universal System Bus (USB) based network controller configured to be connected to a USB based controller of the host system.

15. The data storage device of claim 14, wherein:
the network device comprises a virtual network device connected to the USB based network controller.

16. The data storage device of claim 10, wherein:
the network controller comprises a Thunderbolt based network controller configured to be connected to a Thunderbolt based controller of the host system.

17. The data storage device of claim 16, wherein:
the network device comprises a virtual network device connected to the Thunderbolt based network controller.

18. The data storage device of claim 10, wherein:
the Local Area Network (network) infrastructure further comprises an Enhanced Host Controller Interface Specification (EHCI) USB based network controller configured to be connected to a PCIe compliant bus connector of the host system;
the network controller comprises a virtual USB network controller connected to the EHCI USB based network controller; and
the network device comprises a virtual network device.

19. The data storage device of claim 18, wherein:
the boot image server comprises a BootP boot module enabling the host system to boot from the data storage device.

20. The data storage device of claim 18, wherein:
the boot image server comprises a Preboot Execution Environment (PXE) boot module enabling the host system to boot from the data storage device.

21. The data storage device of claim 1, wherein the network device comprises a wireless network device, and wherein at least one of the network address server module and the file server module is configured to communicate over a wireless connection.

22. A method of providing storage access to a data storage device by a host system, the method comprising:
connecting a network controller of a data storage device to a host computing system, the data storage device including a processor;
providing an indication to the host system to load a driver associated with the network controller;
providing a network address to the host system using a network address server module of the data storage device;
providing boot image information to the host system using a boot image module of the data storage device; and
providing file-level or object-level access to data stored on a non-volatile memory of the data storage device using a file server module of the data storage device;
wherein the method is performed at least in part using the processor.

23. A method of providing access to a data storage device, the method comprising:
connecting a network controller to a host device;
causing the host device to load a driver associated with the network controller;
receiving a network address request from the host device;
providing a network address to the host device in response the request;
receiving a boot image request from the host device;
providing a pointer to a boot image to the host device; and
providing access to a non-volatile memory associated with the data storage device;
wherein the method is performed at least in part by one or more processors of the data storage device.

24. The method of claim 20, wherein said providing the network address is performed using a network address server module of the data storage device.

25. The method of claim 20, wherein said providing the pointer to the boot image is performed using a boot image server of the data storage device.
